(19) United States
(12) Patent Application Publication
(10) Pub. No.: US 2023/0270079 A1
(43) Pub. Date: Aug. 31, 2023

(54) METHOD AND APPARATUS FOR DELIVERING FLUID DROPLETS ONTO AN OPEN AND STATIONARY TRAY

(71) Applicant: Desvac, Saint-Barthelemy D'Anjou (FR)

(72) Inventors: Julie Mars, Saint-Barthelemy D'Anjou (FR); Béatrice Scherdel, Saint-Barthelemy D'Anjou (FR); Olivier Boisdon, Saint-Barthelemy D'Anjou (FR)

(21) Appl. No.: 18/016,417

(22) PCT Filed: Jul. 16, 2021
(86) PCT No.: PCT/FR2021/051334

§ 371 Date: Jan. 16, 2023

(30) Foreign Application Priority Data
Jul. 17, 2020 (FR) FR2007531

(51) Int. Cl. A01K 39/02; B05B 9/00; B05B 13/04; B05B 16/80; A61D 1/02

(52) U.S. Cl. CPC A01K 39/02; B05B 9/007; B05B 13/041; B05B 16/80; A61D 1/025

(57) ABSTRACT

The present invention relates to a method and apparatus for delivering droplets of fluids onto an open tray containing poultry. According to the invention, the apparatus includes a stationary working surface, a single arm carrying a plurality of fluid dispensing nozzles, a drive unit comprising an electric motor for driving the translation of said single arm, said plurality of dispensing nozzles being connected to at least one fluid supply circuit comprising a fluid reservoir for supplying dispensing nozzles, the volume of fluid drawn from said reservoir being determined by a syringe, movement of the plunger of which is controlled by an electrical control element so that the plunger has a feed velocity V in the corresponding syringe. The apparatus also includes a controller for controlling the motor speed and the plunger feed velocity, said controller being configured to synchronize the acceleration/deceleration of the movable arm and the acceleration/deceleration of the plunger of said syringe or of at least one of said syringes.

### TECHNICAL FIELD

The present invention relates to a method for uniformly delivering droplets of different fluids onto birds placed in an open and stationary tray.

It further relates to an apparatus for dispensing droplets of different fluids onto a stationary tray for the implementation of this method.

### PRIOR ART

In order to meet a constantly growing demand for food, animals from intensive farming systems have become increasingly important.

Good health of these animals, in particular to guarantee adequate production, is achieved by the prevention of, and in particular by vaccinations to immunize these animals against, various diseases during the first days of their lives.

For example, in poultry farming, vaccines are typically given to chicks at one day of age or between one (1) and five (5) days of age.

In order to treat a large number of chicks simultaneously, it is known to expose these chicks, arranged in trays or baskets moving on conveyors, to fine droplets of water containing the vaccine to be administered, these droplets being obtained by spraying. Direct contact of these chicks with the mist of droplets ensures their vaccination by the oculonasal route.

It is also known to pass these trays loaded with chicks, by means of conveyors, under nozzles that eject drops of gel containing a vaccine, these drops, which adhere upon contact, being for example colored with a color attractive to the chick. Such coloring also makes it possible to ensure that the product is taken correctly by simple visual inspection of the inside of the animal's mouth.

The drops of gel that fall on the body of each chick are thus pecked by other chicks placed nearby in such a way that each chick receives a sufficient amount of vaccine.

Stationary supports each make it possible to support a set of nozzles to deliver droplets of a specific fluid in a dedicated treatment zone, these supports being arranged to overhang the conveyors transporting the trays loaded with chicks.

Thus, when chicks are intended to receive different treatments, the trays carrying these chicks are conveyed by means of conveyors in different treatment zones spaced apart from one another.

Installations allowing the mass vaccination of live animals, equipped with conveying systems of this type, are thus found to be bulky, and therefore require extensive installation spaces.

Live animal mass vaccination facilities of this type are therefore not suitable for all types of farms, especially small livestock farms.

There is therefore a pressing need for equipment for the mass treatment of live animals having an original design that makes it possible to overcome the drawbacks of the prior art set out above.

### OBJECT OF THE INVENTION

The present invention aims to overcome the drawbacks of the prior art by proposing a method and an apparatus for the mass treatment of living animals, which are simple in design and mode of operation, reliable and fast, and which require a reduced space for installation.

A further object of the present invention is a method and apparatus of this type for the mass treatment of living animals that guarantees homogeneous treatment of each living animal contained in an open tray or basket.

A further object of the present invention is a method and apparatus of this type that minimize the losses of process fluids while ensuring uniform, homogeneous distribution of these fluids over an open tray.

A further object of the present invention is a method and apparatus of this type for managing open trays of different sizes.

The present invention further relates to the use of this method and apparatus for the mass administration of two fluids selected from preventive or therapeutic substances such as vaccines, nutritional substances or even combinations of these elements.

### DISCLOSURE OF THE INVENTION

For this purpose, the invention relates to an apparatus for delivering droplets of fluids onto an open tray containing birds.

According to the invention, this apparatus comprises:
a stationary work surface for receiving and supporting said tray,
a single arm carrying a plurality of fluid-dispensing nozzles,
an electric motor drive unit for moving said single arm in translation in a first direction of the tray when said tray is on said work surface, said arm moving above said tray,
said plurality of dispensing nozzles being connected to at least one fluid supply circuit, each fluid supply circuit comprising a fluid reservoir for supplying corresponding dispensing nozzles with said fluid, the volume of fluid drawn from this reservoir being determined by a syringe, the driving of the plunger of which is controlled by an electrical control element in such a way that said plunger has a feed velocity V in the corresponding syringe, and
a control device for controlling the motor speed of the drive unit and the plunger feed velocity in each syringe, said control device being configured to synchronize the acceleration/deceleration of the movable arm and the acceleration/deceleration of the plunger of said syringe or at least one of said syringes.

Synchronizing the motor speeds of the drive and plunger advance unit of one or at least one of said syringes in this manner advantageously allows acceleration and deceleration of the arm directly above the tray while maintaining a uniform distribution of the droplets of fluid over the open tray.

This minimizes the space required for moving the movable arm and, as a result, the dimensions of the apparatus, which can therefore be made very compact.

It should be noted that, since this apparatus comprises a plurality of fluid supply circuits each supplying different sets of dispensing nozzles, the synchronization of the motor speed of the drive unit is not necessarily carried out with the feed velocity of the plunger of each syringe of the apparatus. It would thus be possible to attempt to time-offset the acceleration and deceleration of the advance of a plunger in a syringe for drawing a fluid from a tank from the acceleration and deceleration of the motor speed of the drive unit for adjusting, for example, the timing of the dispensing of this fluid relative to another fluid.

Since the tray has a rectangular or square section, the first direction is advantageously the length of said tray and the second direction is the width of said tray. Of course, variants are possible.

The term “bird” is understood here to mean any avian species, such as birds of the class Ayes, in other words vertebrate animals which are feathered, winged, bipedal, endothermic (warm-blooded) and capable of laying. In the context of the present invention, “birds” refers more particularly to birds of economic and/or agronomic interest, such as poultry (for example chickens, turkeys, hens, guinea fowl, quail, partridges and pigeons), migratory birds (for example ducks and geese) and ornamental birds (for example swans, parrots and psittacines).

An apparatus of this type for dispensing droplets of fluids has applications in particular in the field of vaccinating chicks within a few days of their birth, in other words between one (1) and five (5) days of age, preferably at one (1) day of age, in other words 24 hours after hatching.

In one embodiment of this apparatus for delivering droplets of fluids, said control device comprises at least one detection element for detecting the motor speed of the drive unit, said at least one detection element emitting synchronization signals.

For purely illustrative purposes, this electric motor being a stepper motor, an optical device may be implemented to detect the number of steps taken by the motor.

These synchronization signals are used to ensure synchronization of the motor speeds of the drive unit and the advancement of the plunger in the syringe or at least one of said syringes.

In another embodiment of this apparatus for delivering droplets of fluids, said control device is configured to define a movement duration of the arm above said tray, comprising a gradual acceleration period, a constant speed period and a gradual deceleration period.

Advantageously, gradual acceleration or deceleration of this type avoids the appearance of jerks in the movement of the arm, which would be likely to cause undesirable fluid losses.

In yet another embodiment of this apparatus for delivering droplets of fluids, the electric motor of the drive unit comprises a toothed wheel, said toothed wheel meshing in a toothed movement path of a guide rail extending along the first direction of the tray.

Alternatively, said drive unit is a linear actuator controlled by said electric motor, the movable arm being mounted perpendicular or substantially perpendicular to the free end of said actuator.

In yet another embodiment of this apparatus for delivering droplets of fluids, it is dimensioned in such a way that at least one of the dimensions of the work surface is at most equal to the corresponding dimension of the open tray that it is intended to support.

Thus, the movable arm only moves above the tray, performing its acceleration and deceleration there.

In yet another embodiment of this apparatus for delivering droplets of fluids, said arm carries a first set of dispensing nozzles for dispensing at least one first fluid and a second set of dispensing nozzles for dispensing at least one second fluid, distinct from the at least one first fluid, the dispensing nozzles of each set being arranged in such a way that the entire dimension of the tray in a second direction perpendicular to the first direction is covered by these first and second sets of dispensing nozzles when said tray is received on said work surface.

Advantageously, this apparatus is configured to provide a time offset between the dispensing of at least one first fluid by means of said first set of dispensing nozzles and at least one second fluid by means of said second set of dispensing nozzles. For example, the first and second sets of dispensing nozzles are spaced apart on said arm in the first direction by a distance that defines said time offset. Advantageously, this spacing is calculated to guarantee effective treatment of the birds with the second fluid.

By way of example, the spacing between the two (2) sets is between 4 and 10 cm, preferably between 4 and 7 cm, and even more preferably the spacing is 5 cm.

In yet another embodiment of this apparatus for delivering droplets of fluids, the first set of nozzles comprises nozzles for dispensing a fluid by spraying and the second set of nozzles comprises nozzles for dispensing a fluid by spraying or needles for ejecting individual drops of a fluid.

While being advantageously compact, this apparatus makes it possible to deliver two distinct fluids such as a spray and a gel within a very short time interval, or even almost simultaneously, for the mass treatment of the birds placed in a tray or basket. Creating a time offset between the dispensing of the two fluids makes it possible to avoid the dilution of drops of gel by the mist of droplets of the first fluid.

Spray dispensing nozzles may have flat or conical heads. Preferably, they are flat to form a curtain of droplets.

Each of these needles is configured to eject an individual drop of fluid through its orifice for a given fluid pressure

In yet another embodiment of this apparatus for delivering droplets of fluids, it comprises at least one optical device for determining the dimensions of the tray, the control device being configured to adjust the positioning of said arm on a first end of said tray, as considered along the first direction, before said droplets of fluid are dispensed.

In yet another embodiment of this apparatus, it comprises a plurality of sensors to automatically trigger the dispensing of droplets by the apparatus. Alternatively, this triggering may be performed manually by the operator. By way of example, one or more cameras and a computer program for processing the images received from the camera or cameras can make it possible to detect the correct positioning of the basket before triggering the actuation of the movable arm. The actuation may involve be a combination of positioning sensors and manual actuation by the operator.

An apparatus of this type has applications in particular in the veterinary field, in particular in the mass vaccination of chicks.

The present invention also relates to a method for delivering droplets of fluids onto an open tray containing birds, said tray being stationary.

According to the invention,
a movable arm is moved above said tray, in translation along a first direction of said tray, said arm carrying a plurality of fluid-dispensing nozzles, said dispensing nozzles being arranged to cover the entire dimension of the tray in a second direction perpendicular to the first direction,
said plurality of dispensing nozzles being connected to at least one fluid supply circuit, each fluid supply circuit comprising a fluid reservoir for supplying corresponding dispensing nozzles with said fluid, the volume of fluid drawn from the reservoir being determined by a syringe, the driving of the plunger of which is controlled by an electrical control element, in such a way that said plunger has a feed velocity V in the corresponding syringe, the movement speed of said movable arm is synchronized with the plunger advance rate of said syringe or at least one of said syringes, and
the acceleration and the deceleration of the arm are performed above said tray to minimize the movement stroke of the arm.

In one embodiment of this method for delivering droplets of fluids, while said arm carries a first set of dispensing nozzles and a second set of dispensing nozzles, said nozzles of each set being arranged to cover the entire dimension of the tray in a second direction perpendicular to the first direction, droplets of at least one first fluid are simultaneously dispensed by means of said first set of dispensing nozzles and droplets of at least one second fluid, distinct from the first fluid, are dispensed by means of said second set of dispensing nozzles. An embodiment of this type would for example be suitable for dispensing two separate sprays.

Alternatively, while said arm carries a first set of dispensing nozzles and a second set of dispensing nozzles, the nozzles of each set being arranged to cover the entire dimension of the tray in a second direction perpendicular to the first direction, the following steps are carried out:
a) initially droplets of at least one first fluid are dispensed by spraying by means of the first set of dispensing nozzles, and
b) subsequently at least one second fluid, distinct from said at least one first fluid to be sprayed, is dispensed by ejecting individual drops by means of the second set of dispensing nozzles.

This method therefore makes it possible to administer at least two distinct fluids to chicks contained in an open tray or basket within a very short time, while ensuring homogeneous treatment of each chick.

The original design of this method requires a reduced space for its implementation and it is therefore particularly suitable for implementation in small farms.

It is advantageously reliable and economical.

Since this movable arm is advantageously adjustable in height, this method can be implemented with any type of open tray. The width adjustment is carried out by removing, blocking by plug, or not using certain nozzles and/or deposition needles located on the periphery of the movable arm.

Advantageously, a method of this type is particularly suitable for administering a spray (a first fluid) and a gel (a second fluid).

Preferably, steps a) and b) are carried out in a single pass of the movable arm above the tray, said sets of nozzles being arranged on this arm so as to generate a time offset between steps a) and b).

Advantageously, the time offset between steps a) and b) is determined so as to guarantee effective treatment of the birds with said at least one second fluid. This ensures that each bird is directly exposed to the second fluid or consumes a sufficient amount of said second fluid in such a way that the mass treatment of the birds is homogeneous.

In other words, the time interval between the steps a) and b) of dispensing fluids is calculated to prevent the mist of droplets obtained from dispensing the first fluid by means of the first set of dispensing nozzles from being able to reduce the adhesion or wetting of the drops of the second fluid ejected by the second set of dispensing nozzles, in particular when said second fluid is a gel.
Alternatively, step a) is carried out when said arm is moving from a first edge to a second edge of said tray, said second edge being opposite the first edge, on a forward path extending along the first direction, and step b) is carried out when said arm is moving from the second edge to the first edge on a return path along the first direction.

In yet another embodiment of this method for delivering droplets of fluids onto an open tray, the first fluid is a liquid to be sprayed and the second fluid is a gel such as a soft gel, or a fluid having a viscosity between 50 and 200 cP at 20° C. Preferably, the viscosity of this fluid is between 50 and 180 cP at 20° C. and even better between 54 and 177 cP at 20° C. Even more preferably, the viscosity is between 100 and 120 cP at 20° C.

For purely illustrative purposes, the first fluid is an aqueous composition containing a vaccine.
This gel may include a coloring agent for visual inspection of the uniform distribution of the drops over the open tray.

In yet another embodiment of this method for delivering droplets of fluid onto an open tray, in each of steps a) and b), a plurality of droplets having a uniform or substantially uniform size are formed.

To achieve this, the fluid supply pressure can be controlled at each nozzle of each assembly for a given type of nozzle.
Preferably, in step a) a mist of droplets is formed, at least 80%, preferably at least 90%, of these droplets having a size between 145 microns and 230 microns.
Advantageously, in step b) a plurality of droplets are formed, at least 80%, preferably at least 90%, of these droplets having a size between 900 microns and 1500 microns.

In yet another embodiment of this method for delivering droplets of fluids onto an open tray, the flow rate at said nozzles and the movement speed of the movable arm are controlled to ensure a uniform or substantially uniform distribution of said droplets over the tray.

Preferably, the flow rate at each of said nozzles, delivering the first fluid, is between 6 ml/s and 40 ml/s, preferably between 8 ml/s and 20 ml/s, and the flow rate at each of said needles, delivering the second fluid, is between 15 ml/s and 50 ml/s, preferably between 15 ml/s and 25 ml/s. The pressure applied to deliver the first fluid is between 3 and 130 bars, and the pressure applied to deliver the second fluid is between 0.2 and 1 bar.

In yet another embodiment of this method for delivering droplets of fluids onto an open tray, said fluids incorporate one or more active substances for vaccinating avian species such as birds or fluids other than vaccines such as nutritional compositions.

In yet another embodiment of this method for delivering droplets of fluids onto an open tray, at least two distinct first fluids are dispensed by spraying and/or at least two distinct second fluids are dispensed by ejecting individual drops.

For purely illustrative purposes, each set of dispensing nozzles may include two rows of nozzles for dispensing two different products in a single pass.
The present method thus also covers dispensing two or more distinct fluids to be sprayed or atomized and/or two or more fluids to be ejected in the form of individual drops. The latter fluids are preferably ejected by means of needles.

### BRIEF DESCRIPTION OF THE DRAWINGS

Further advantages, aims and particular features of the present invention will become clear from the following description, provided for illustrative and non-limiting purposes, in conjunction with the accompanying drawings, in which:

FIG. 1

FIG. 1 is a front view of an apparatus for the mass treatment of chicks according to a particular embodiment of the present invention;

FIG. 2

FIG. 2 is a perspective view of the apparatus of FIG. 1;

FIG. 3

FIG. 3 is another perspective view of the apparatus of FIG. 1;

FIG. 4

FIG. 4 is a perspective view and a top view of the apparatus of FIG. 1, a basket containing chicks being placed in its working zone and awaiting processing;

FIG. 5 is a cross-sectional view of the apparatus of FIG. 1, a basket containing chicks being placed in its working zone and awaiting processing;

FIG. 6

FIG. 6 shows the three operating phases of the motor of the drive unit of the movable arm, with acceleration, plateau and deceleration, and the identical phases of fluid flow at the outlet of each syringe of the mass treatment apparatus of FIGS. 1 to 5.

### DESCRIPTION OF AN EMBODIMENT

The drawings and the description below contain, for the most part, elements that are certain in nature. They may therefore not only convey an improved understanding of the present invention, but also potentially contribute to defining it.

First, it is noted that the figures are not to scale.

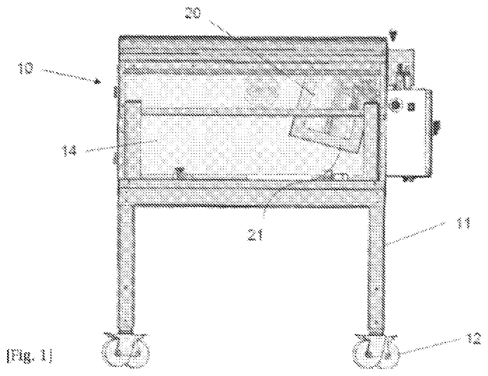

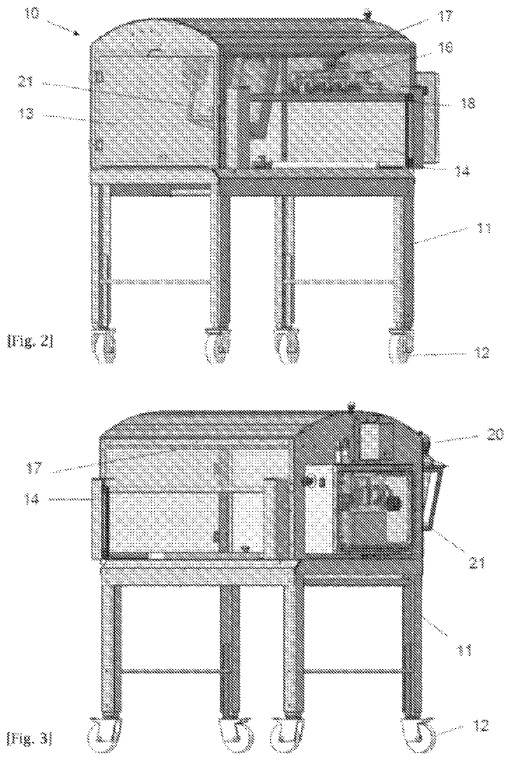

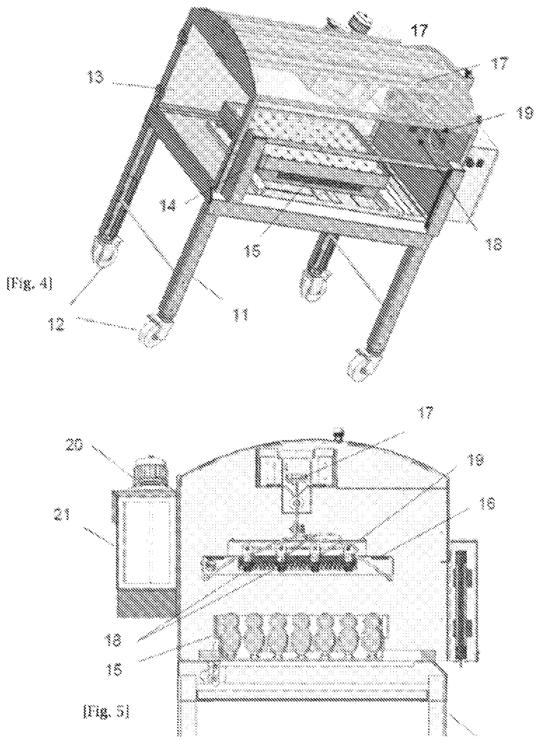

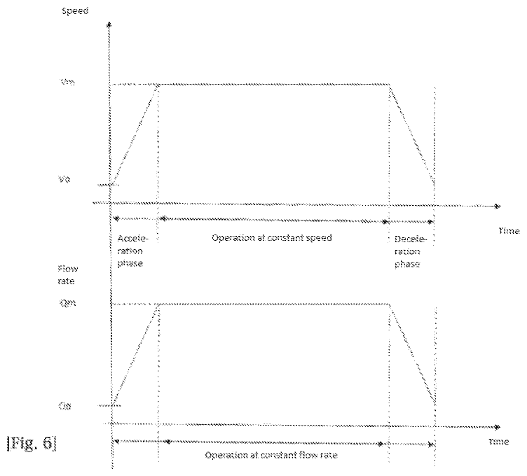

FIGS. 1 to 5 schematically show an apparatus for the mass treatment of chicks 20 according to a particular embodiment of the present invention.

This apparatus comprises a frame 10 provided with feet 11, comprising at their free ends rollers 12 to provide movement of said frame. The apparatus may have 2 to 4 wheels 12. Each of these rollers 12 may include a blocking member (not shown) for fixing the apparatus in position.

This frame 10 comprises in its upper part an enclosed space delimited by walls 13, which are transparent at least in part for viewing the interior of said space. One of these walls 13 comprises a flap 14, which is movable in vertical translation to allow access to this enclosed space, in particular for introducing and removing a basket 15 loaded with chicks, and also for cleaning and maintaining the apparatus. In addition to this physical barrier formed by the movable flap 14, if it is desired for the apparatus to be able to remain open, said apparatus may include one or more protective elements (not shown) to detect the presence of an object intruding in the treatment zone, such as an operators hand or arm. Said protection element or elements are capable of sending detection signals to a central processing unit, which can stop processing that is underway or even prevent the triggering of the processing. By way of example, said protection element or elements are infrared detectors.

Of course, it is also possible for the frame 10 to be free of a movable flap 14 of this type or even of protective elements of this type.

The interior of this enclosed space comprises a working zone intended to receive and support a basket 15 open for treatment, this basket 15 then being in a stationary position.

A movable arm 16, mounted on a longitudinal rail 17 defining a first direction, can move in translation along said rail 17 above the working zone. The longitudinal rail 17 is secured to the upper end, or cover, of the frame 10.

Said movable arm 16 is driven in movement by a drive unit comprising an electric motor comprising a toothed wheel, said toothed wheel meshing in a toothed movement path of the longitudinal rail 17 extending along the first direction of the basket 15.

This movable arm 16 carries a set of nozzles 18 and a set of deposition needles 19, said nozzles and needles being arranged on the movable arm 16 in such a way that the entire dimension of the basket 15 in a second direction, perpendicular to the first direction defined by the longitudinal rail 17, is entirely covered by the set of nozzles 18 and by the set of deposition needles 19.

These nozzles and needles may be individually movable along the movable arm 16 to allow adjustment of the coverage of different baskets.

Of course, this apparatus may include position sensors (not shown) to determine the precise positioning of the basket in the working zone. It is then possible to automate the fluid-dispensing sequences by way of automatic recognition of the type of basket 15 placed in the dispensing device.

The set of nozzles 18 comprises spray dispensing nozzles, while the other set comprises deposition needles 19, each of these needles comprising an orifice, each needle being configured to eject an individual drop of fluid through its orifice for a given fluid pressure.

While being advantageously compact, this apparatus makes it possible to deliver two distinct fluids such as a spray and a gel within a very short time interval, or even almost simultaneously, for the mass treatment of the birds placed in an open basket 15.

This apparatus thus comprises two reservoirs 20, which are placed in a support 21 at the height of the user, these reservoirs 20 advantageously being transparent for inspecting the available fluid level in each of them.

Each fluid supply circuit connecting a reservoir 20 to its corresponding set of nozzles and deposition needles comprises a syringe 22 allowing the fluid to be drawn from its corresponding reservoir to send it into the supply circuit. Each syringe comprises a plunger, the movement of which is ensured by an electric motor. Each plunger thus has a feed velocity V in the corresponding syringe.

The feed rates of the nozzles and needles, as well as the movement speed of the movable arm 16, are controlled to guarantee uniform and homogeneous distribution of the dispensed fluids over the open basket 15.

More particularly, said apparatus comprises a control device for controlling the motor speed of the drive unit of the movable arm 16 and the feed velocity V of the plunger in each syringe, said control device being configured to synchronize the acceleration/deceleration of the movable arm 16 and the acceleration/deceleration of the plunger of each syringe.

Thus the flow rate of each fluid in each supply circuit follows operating phases the same as those of the motor of the movable arm drive unit, namely:
a first startup and acceleration phase,
a plateaued operation phase at a maximum possible speed Vm, and
a deceleration and motor stopping phase, symmetrical with the first phase.

An embodiment of this type allows movement of the movable arm above the single basket 15 while guaranteeing a uniform distribution of the droplets over this open basket. The apparatus can therefore be of reduced dimensions.

Advantageously, the acceleration and deceleration phases are performed gradually to avoid any jerks in the movement of the movable arm 16.

The set of nozzles 18 and the set of deposition needles 19 are also arranged on the movable arm 16 to ensure a time offset between the dispensing of the first fluid (vaporizable fluid) and second fluid (gel).

Since this elongated movable arm 16 comprises two lateral edges defining a front face and a rear face, as considered in the direction of movement of this arm in translation along the first direction, the set of nozzles 18 is mounted on the front face of said movable arm 16 while the set of deposition needles 19 is mounted on the rear face of said arm 16, thus being spaced apart from the set of nozzles 18 along the first direction.

This ensures that the dispensing of the droplets of the first fluid by the first set of nozzles 18 by spraying, or even by atomization, always precedes the dispensing of the drops of the second fluid by the set of deposition needles 19. There is thus no risk that the mist of droplets formed by spraying the first fluid could prevent the adhesion of the drops of the second fluid to the feathers of the chicks, potentially leading to uneven treatment of said chicks.

In one embodiment of the present apparatus, the minimum distance d spatially separating the set of nozzles 18 from the set of deposition needles 19, along the first direction, is between 5 and 9 cm. The movement speed of the arm in its range of uniform movement is between 35 and 80 cm/s, preferably 55 cm/s.

1. An apparatus for delivering droplets of fluids onto an open tray (15) containing birds, characterized in that it comprises:
a stationary work surface for receiving and supporting said tray (15),
a single arm (16) carrying a plurality of fluid-dispensing nozzles,
an electric motor drive unit for moving said single arm (16) in translation in a first direction of the tray (15) when said tray is on said work surface, said arm (16) moving above said tray (15),
said plurality of dispensing nozzles being connected to at least one fluid supply circuit, each fluid supply circuit comprising a fluid reservoir for supplying corresponding dispensing nozzles with said fluid, the volume of fluid drawn from this reservoir being determined by a syringe, the driving of the plunger of which is controlled by an electrical control element in such a way that said plunger has a feed velocity V in the corresponding syringe, and
a control device for controlling the motor speed of the drive unit and the plunger feed velocity in each syringe, said control device being configured to synchronize the acceleration/deceleration of the movable arm (16) and the acceleration/deceleration of said plunger of said syringe or at least one of said syringes.

2. The apparatus according to claim 1, characterized in that said control device comprises at least one detection element for detecting the motor speed of the drive unit, said at least one detection element emitting synchronization signals.

3. The apparatus according to claim 1, characterized in that said control device is configured to define a movement duration of the arm (16) above said tray (15), comprising a gradual acceleration period, a constant speed period and a gradual deceleration period.

4. The apparatus according to claim 1, characterized in that the electric motor of the drive unit comprises a toothed wheel, said toothed wheel meshing in a toothed movement path of a guide rail extending along the first direction of the tray (15).

5. The apparatus according to claim 1, characterized in that the drive unit is a linear actuator controlled by said electric motor, said movable arm (16) being mounted perpendicular to the free end of said actuator.

6. The apparatus according to claim 1, characterized in that said apparatus is dimensioned in such a way that at least one of the dimensions of said work surface is at most equal to the corresponding dimension of said open tray (15) that it is intended to support.

7. The apparatus according to claim 1, characterized in that said arm (16) carries a first set of dispensing nozzles (18) for dispensing at least one first fluid and a second set of dispensing nozzles (19) for dispensing at least one second fluid, distinct from the at least one first fluid, the dispensing nozzles of each set being arranged in such a way that the entire dimension of the tray (15) in a second direction perpendicular to the first direction is covered by these first and second sets of dispensing nozzles when said tray (15) is received on said work surface.

8. The apparatus according to claim 7, characterized in that it is configured to provide a time offset between the dispensing of at least one first fluid by means of said first set of dispensing nozzles (18) and at least one second fluid by means of said second set of dispensing nozzles (19).

9. The apparatus according to claim 8, characterized in that said first and second sets of dispensing nozzles (18, 19) are spaced apart on said arm (16) in the first direction of a distance that determines said time offset.

10. The apparatus according to claim 7, characterized in that said first set of nozzles (18) comprises nozzles for dispensing a fluid by spraying and in that said second set of nozzles (19) includes nozzles for dispensing a fluid by spraying or needles for ejecting individual drops of a fluid.

11. The apparatus according to claim 1, characterized in that it comprises at least one optical device for determining the dimensions of said tray (15), said control device being configured to adjust the positioning of said arm (16) on a first end of said tray (15) before said droplets of fluid are dispensed.

12. A method for delivering droplets of fluids onto an open tray (15) containing birds, said tray (15) being stationary, characterized in that:
a movable arm (16) is moved above said tray (15), in translation along a first direction of said tray (15), said arm (16) carrying a plurality of fluid-dispensing nozzles, said dispensing nozzles being arranged to cover the entire dimension of the tray (15) in a second direction perpendicular to the first direction,
said plurality of dispensing nozzles being connected to at least one non-therapeutic fluid supply circuit, each fluid supply circuit comprising a non-therapeutic fluid reservoir for supplying corresponding dispensing nozzles with said fluid, the volume of fluid drawn from this reservoir being determined by a syringe, the driving of the plunger of which is controlled by an electrical control element in such a way that said plunger has a feed velocity V in the corresponding syringe, the movement speed of this movable arm (16) being synchronized with the plunger advance rate of said or at least one of said syringes, and
the acceleration and the deceleration of the arm (16) are performed above said tray (15) to minimize the movement stroke of the arm (16).

13. The method according to claim 12, characterized in that said arm (16) carrying a first set of dispensing nozzles (18) and a second set of dispensing nozzles (19), the said nozzles of each set being arranged to cover the entire dimension of the tray (15) in a second direction perpendicular to the first direction, droplets of at least one first fluid are simultaneously dispensed by means of said first set of dispensing nozzles and droplets of at least a second fluid, separate from the first fluid by means of said second set of dispensing nozzles.

14. The method according to claim 12, characterized in that while said arm (16) carries a first set of dispensing nozzles (18) and a second set of dispensing nozzles (19), said nozzles of each set being arranged to cover the entire dimension of the tray (15) in a second direction perpendicular to the first direction, the following steps are carried out:
a) initially droplets of at least one first fluid are dispensed by spraying by means of the first set of dispensing nozzles (18), and
b) subsequently at least one second fluid, distinct from said at least one first fluid to be sprayed, is dispensed by ejecting individual drops by means of the second set of dispensing nozzles (19).

15. The method according to claim 14, characterized in that steps a) and b) are carried out in a single pass of the movable arm (16) above said tray (15), said sets of nozzles being arranged on said arm so as to generate a time offset between steps a) and b).

16. The method according to claim 15, characterized in that the time offset between steps a) and b) is determined so as to guarantee effective treatment of the birds with said at least one second fluid.

17. The method according to claim 14, characterized in that step a) is carried out when said arm is moving from a first edge to a second edge of said tray (15), said second edge being opposite the first edge, on a forward path extending along the first direction, and step b) is carried out when said arm is moving from the second edge to the first edge on a return path along the first direction.
